(19) United States
(12) Patent Application Publication
(10) Pub. No.: US 2010/0255271 A1
(43) Pub. Date: Oct. 7, 2010

(54) PLASTIC ARTICLE

(75) Inventors: CHUN-YUAN CHANG, Tu-Cheng (TW); CHUNG-CHI TSENG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/732,145

(22) Filed: Mar. 25, 2010

(30) Foreign Application Priority Data
Apr. 2, 2009 (TW) 98110976
Apr. 9, 2009 (TW) 98111789

(51) Int. Cl. B32B 3/10

(52) U.S. Cl. 428/201

(57) ABSTRACT

A plastic article is provided. The plastic article includes a base formed by injecting molten resin into a cavity of a female mold and a film attached to the base. The base includes a top portion and a flange extending from edges of the top portion. The base includes a first edge formed from edges of the flange. The film includes a second edge level to the first edge of the base. The film fully covers the top portion and the flange.

### CROSS-REFERENCE TO RELATED APPLICATION

Relevant subject matter is disclosed in a co-pending U.S. patent application (Attorney Docket No. US26630) filed on the same date and entitled “PLASTIC ARTICLE AND METHOD OF MANUFACTURING THE SAME”, which is assigned to the same assignee with this patent application.

### BACKGROUND

1. Technical Field

The disclosure relates to a plastic article, and particular to a plastic article manufactured by in-mold-decoration (IMD) method.

2. Description of Related Art

A common method for IMD includes the following steps: cutting an attached film according to a surface of the plastic article from a film roll, putting the attached film into a cavity of a mold, injecting, molding then opening the mold to retrieve the plastic article complete with the film attached thereto. However, the attached film shrinks very easily, while in the injection process, and thus, will not completely cover the surface of the plastic article.

### BRIEF DESCRIPTION OF THE DRAWINGS

FIG. 1 is a cross-sectional view of an injection mold used in an exemplary embodiment of a method of manufacturing a plastic article.

FIG. 2 is a cross-sectional view of a variational injection mold used in the method of manufacturing the plastic article.

FIG. 3 is similar to FIG. 1, but showing the injection mold closed to a first position.

FIG. 4 is similar to FIG. 3, but showing the injection mold closed to a second position.

FIG. 5 is a flowchart of a first exemplary embodiment of a method for manufacturing the plastic article.

FIG. 6 is a flowchart of a second exemplary embodiment of the method for manufacturing the plastic article.

FIG. 7A is a schematic view of a plastic article manufactured by the method.

FIG. 7B is a cross-sectional view of the plastic article of FIG. 7A, taken along the line of 7B-7B.

FIG. 8A is a schematic view of another plastic article manufactured by the method.

FIG. 8B is a cross-sectional view of the plastic article of FIG. 8A, taken along the line of 8B-8B.

FIG. 9A is a cross-sectional view of the plastic article of FIG. 7B, taken along the line of 9-9, and showing a structure of an attached film.

FIG. 9B is a cross-sectional view of the plastic article of FIG. 7B, taken along the line of 9-9, and showing an altered structure of the attached film.

FIG. 10 is a cross-sectional view of a structure of a second embodiment of an attached film.

FIG. 11 is a cross-sectional view of a structure of a third embodiment of an attached film.

### DETAILED DESCRIPTION

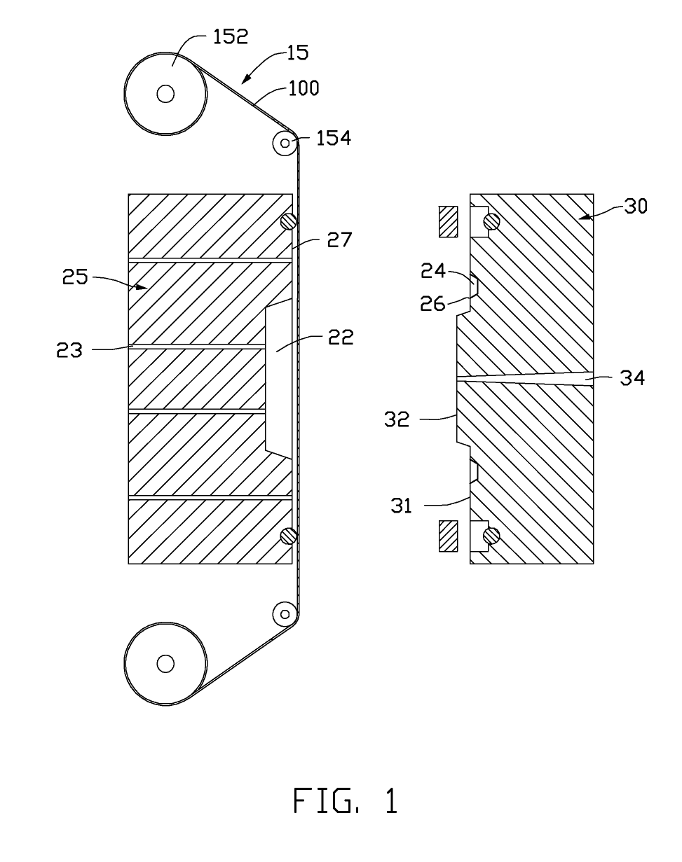

Referring to FIG. 1, an exemplary embodiment of an injection mold for in-mold-decoration includes a transport 15, a female mold 25, and a male mold 30.

The transport 15 includes two transporting rollers 152 and two guiding rollers 154 positioned at opposite ends of the mold respectively, for transporting a film 100 into the female and male molds 25 and 30.

The female mold 25 defines a cavity 22 in a first side 27. A plurality of air venting holes 23 define in the female mold 25 and connect to the cavity 22. Each air venting hole connects to a vacuum pump (not shown) for adsorbing the film 100 that disposes into the female and male molds 25 and 30 into the cavity 22.

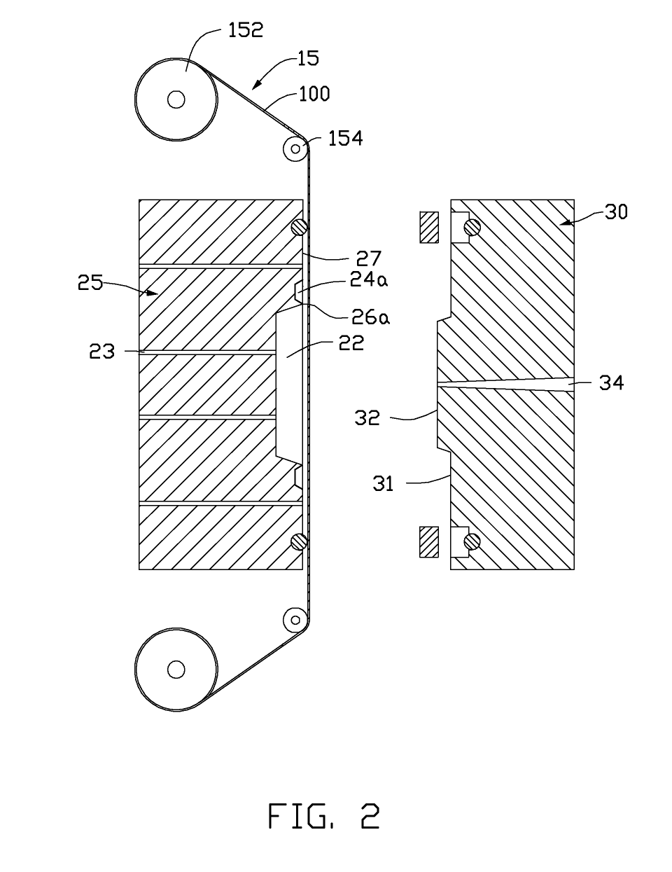

The male mold 30 includes a second side 31 facing the first side 27 of the female mold 25, the second side 31 forms a protrusion 32 protruding towards the female mold 25 and mating with the cavity 22 of the female mold 25. An injection port 34 is defined in a center of the protrusion 32, for injecting molten resin into the cavity 22. A slot 24 defines in the second side 31 of the male mold 30 around the protrusion 32. A cutting portion 26 forms on a wall bounding the slot 24 between the protrusion 32 and the slot 24. Referring to FIG. 2, the female mold 25 defines a slot 24a around the cavity 22. A cutting portion 26a is formed on a wall bounding the slot 24a and the cavity 22.

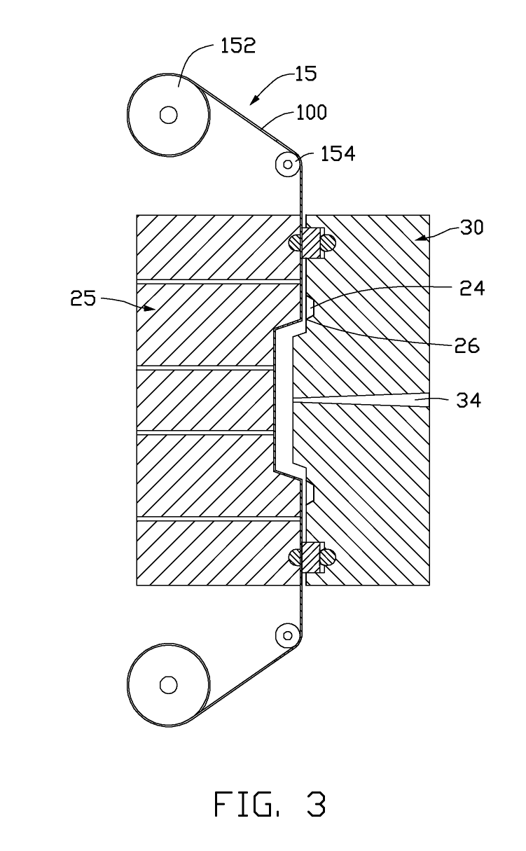

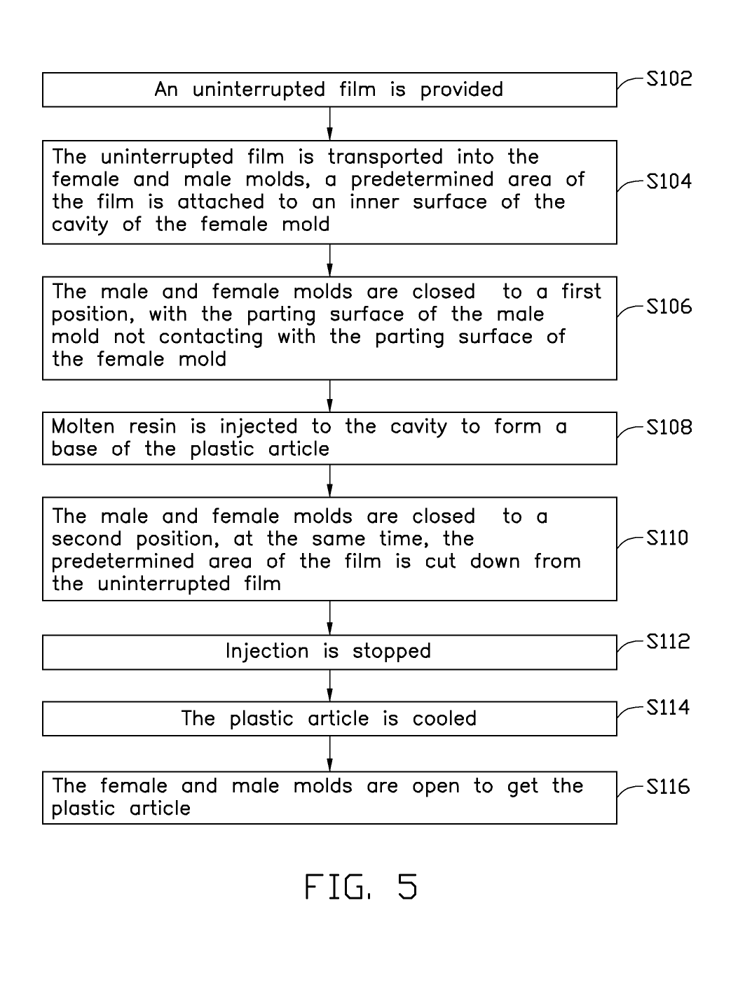

Referring to FIGS. 3-5, a first exemplary embodiment of a method using the above-mentioned injection mold to manufacture a plastic article, includes the following steps:

Step S102, the uninterrupted film 100 with patterns and characters printed thereon, is provided, and rolled around the transporting roller 152 of the transport 15.

Step S104, the uninterrupted film 100 is transported between the female and male molds 25 and 30 by the transport 15, a predetermined area of the film 100 attaches to an inner surface of the cavity 22 of the female mold 25. In one embodiment, the predetermined area of the film 100 attaches to the inner surface of the cavity 22 by vacuumizing the cavity 22 through the plurality of venting holes 23 of the female mold 25.

Step S106, the male and female molds 30 and 25 close to a first position, with the parting surface of the male mold 30, the second side 31, not contacting the parting surface of the female mold 25, the first side 27.

Step S108, molten resin is injected into the cavity 22 through the injection port 34 of the male mold 30 to form a base of the plastic article. At first about 90%-99.5% of the molten resin is injected into the cavity 22. In this process, the predetermined area of the film 100 attaches to the base of the plastic article.

Step S110, the male and female molds 30 and 25 close to a second position, at this time, the remnant of molten resin is injected into the cavity 22. The parting surface of the male mold 30 presses the parting surface of the female mold 25, thus the cutting portion 26 of the male mold 30 cuts the predetermined size of the film 100 attached to the base of the plastic article.

Step S112, injection stops.

Step S114, the plastic article cools.

Step S116, the female and male molds 25 and 30 open to retrieve the plastic article whose surface is covered by the film 100. At this time, the transport 15 transports the film 100 to prepare a next molding cycle.

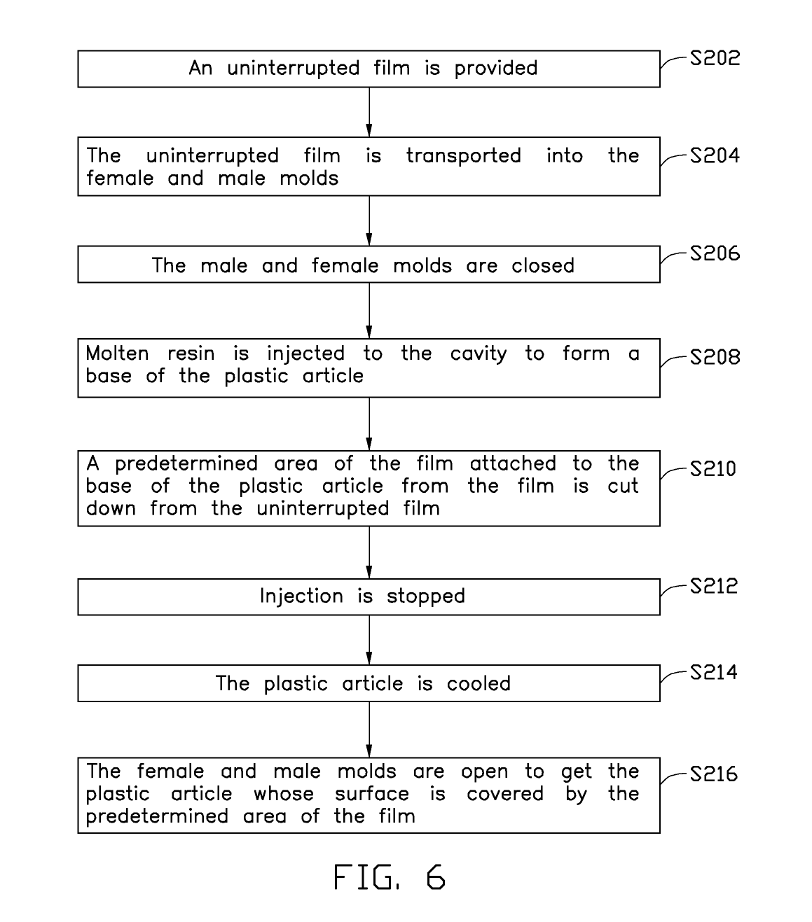

Referring to FIG. 6, a second embodiment of a method for manufacturing a plastic article includes the following steps:

Step S202, an uninterrupted film 100 with patterns and characters printed thereon, is provided, and rolled around the transporting roller 152 of the transport 15.

Step S204, the uninterrupted film 100 is transported between the female and male molds 25 and 30 by the transport 15, a predetermined area of the film 100 is attached to an inner surface of the cavity 22 of the female mold 25, as shown in FIG. 3.

In one embodiment, the predetermined area of the film 100 attaches to the inner surface of the cavity 22 by vacuumizing the cavity 22 through the plurality of venting holes 23 of the female mold 25.

Step S206, the male and female molds 30 and 25 are closed.

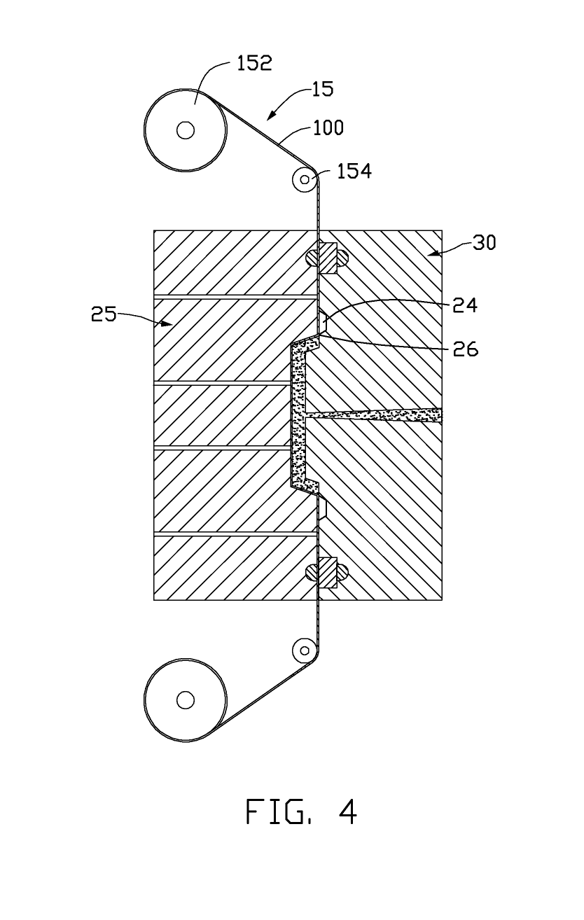

Step S208, molten resin is injected into the cavity 22 from the injection port 34 of the male mold 30 to form a base of the plastic article, as shown in FIG. 4.

Step S210, the predetermined area of the film 100 attached to the base of the plastic article from the film 100 is cut from the uninterrupted film 100 after about 90%-99.5% of the molten resin is injected into the cavity 22.

Step S212, injection stops.

Step S214, the plastic article cools.

Step S216, the female and male molds 25 and 30 open to retrieve the plastic article whose surface is covered by the predetermined area of the film 100 from the mold. At the same time, the transport 15 transports the film 100 to prepare for the next molding cycle.

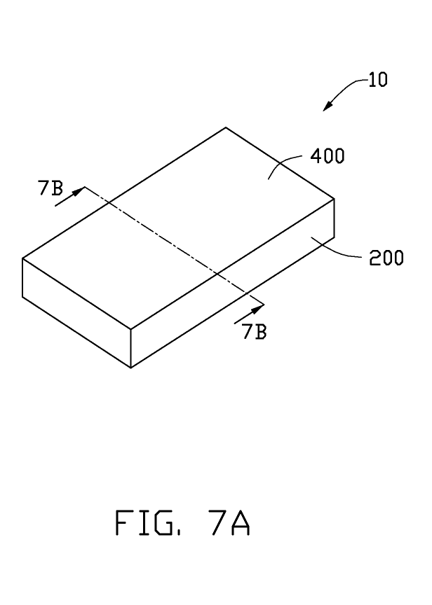

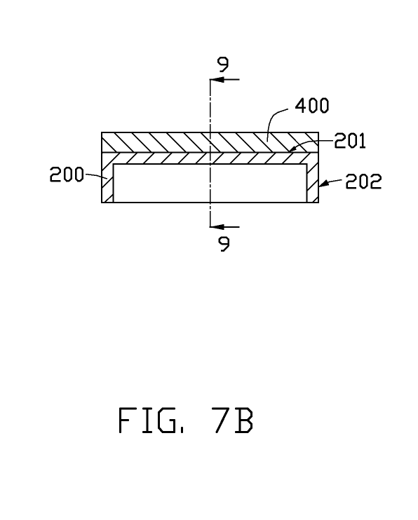

Referring to FIGS. 7A and 7B, a plastic article 10 manufactured by the above-mentioned methods includes a base 200 and an attached film 400 cut from the film 100. The base 200 includes a top portion 201 and a flange 202 extending from edges of the top portion 201. The attached film 400 attaches to the top portion 201 of the base 200 opposite to the flange 202 and fully covers the top portion 201.

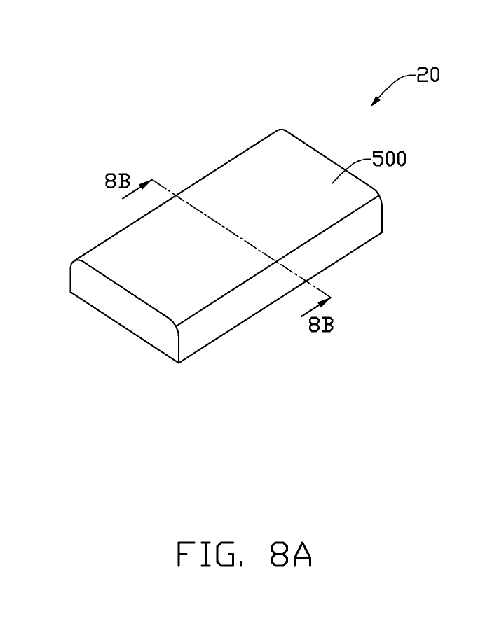

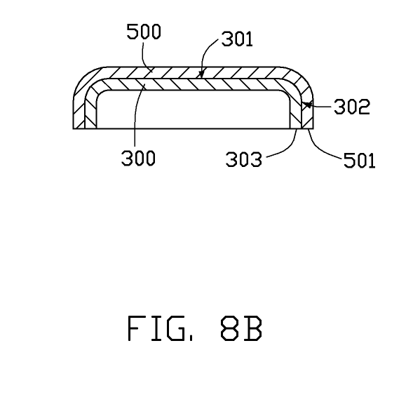

Referring to FIGS. 8A and 8B, another plastic article 20 manufactured by the above-mentioned methods includes a base 300 and an attached film 500. The base 300 includes a top portion 301 and a flange 302 extending from edges of the top portion 301. The attached film 500 attaches to the top portion 301 of the base 300 opposite to the flange 302 and fully covers the top portion 301 and the flange 302.

In this embodiment, the base 300 includes a first edge 303. The attached film 500 includes a second edge 501 joining and being level to the first edge 303 of the base 300.

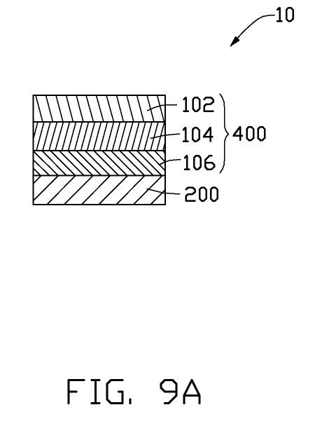

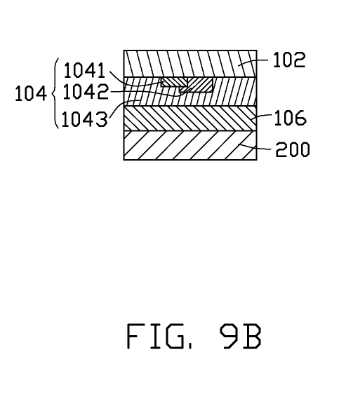

Referring to FIG. 9A, the film 100 includes a base layer 102, a pattern layer 104 having different patterns and characters and printed on the base layer 102 by printing ink, and an attaching layer 106. The pattern layer 104 is sandwiched between the base layer 102 and the attaching layer 106.

The base layer 102 functions as a scratch/abrasion-resistant for the pattern layer 104. The base layer 102 generally consists of at least one polycarbonate, polyethylene terephthalate, acrylic, oriented polypropylene, or polyvinyl chloride, for example. The thickness of the base layer 102 can range from about 0.01 millimeters to about 0.125 millimeters.

The pattern layer 104 is arranged on the inner surface of the base layer 102. Referring to FIG. 9B, the pattern layer 104 includes a plurality of ink layers provided via screen printing, such as ink layers 1041, 1042, and 1043. The thickness of each ink layer can range from about 0.005 millimeters to about 0.02 millimeters. A metal decorative layer can be provided as the pattern layer 104. The metal decorative layer plating may be aluminum, chromium, copper, nickel, indium, or tin, alone or combined, on the base layer 102 via either a vacuum evaporation or electroplating method.

The attaching layer 106 is for attaching the film 100 to the outer surface 32 of the plastic article 30. The attaching layer 106 may be made from a plurality of resin materials consisting of acrylic, nitrification fiber, polyamine formate, chlorination rubber, vinyl chloride-co-vinyl-acetic ester copolymer, polyamide, polyester, epoxy, polycarbonate, olefin, and acrylonitrile-butylene-styrene monomer resin, for example. The attaching layer 106 is generally provided via concave, screen, and offset printing, or spraying, dip-coating method, or a coating in reverse order method, for example.

The base layer 102 may be either transparent or translucent to reveal the patterns and/or colors of the pattern layer 104.

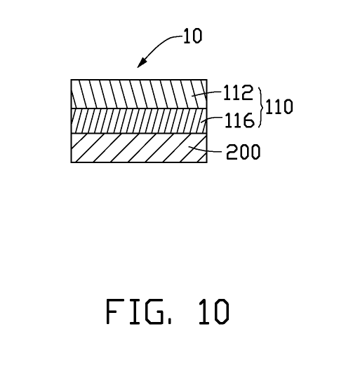

Referring to FIG. 10, in a second embodiment, a film 110 includes a base layer 112 and an attaching layer 116 directly attached to the base layer 112, but does not include a pattern layer, for highlighting the natural color of the base 200 of the plastic article 10 through the transparent or translucent base layer 112. It is noteworthy that in other embodiments, the base layer 112 may be made of a colored material, for adding color to the plastic article.

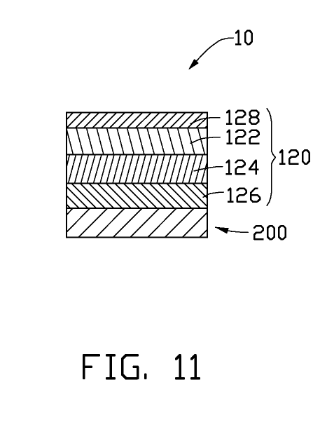

Referring to FIG. 11, in a third embodiment of this disclosure, the plastic article 10 may include an attached film 120 attached to the base 200 of the plastic article 10. The attached film 120 includes a base layer 122, a first pattern layer 124, a second pattern layer 128, and an attaching layer 126. The second pattern layer 128 directly attaches to the base layer 122 opposite to the first pattern layer 124.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A plastic article, comprising:
a base formed by injecting molten resin into a cavity of a female mold, the base comprises a top portion and a flange extending from edges of the top portion; and
a film attached to the base, the film comprising a base layer and an attaching layer attaching the base layer to the base;
wherein the base comprises a first edge, the film comprises a second edge joining and being level to the first edge of the base;
wherein the base layer functions as a scratch/abrasion-resistant for the pattern layer, a thickness of the base layer ranges from about 0.01 millimeters to about 0.125 millimeters.

2. The plastic article of claim 1, wherein the film further comprises a pattern layer having patterns and/or characters printed on the base layer and sandwiched between the base layer and the attaching layer.

3. The plastic article of claim 2, wherein the base layer is either transparent or translucent to reveal the pattern and/or characters of the pattern layer.

4. The plastic article of claim 2, wherein the pattern layer comprises a plurality of ink layers provided via screen printing, a thickness of each ink layer ranges from about 0.005 millimeters to about 0.02 millimeters.

5. The plastic article of claim 2, wherein a metal decorative layer is provided as the pattern layer, the metal decorative layer plating may be aluminum, chromium, copper, nickel, indium, or tin, alone or combined, on the base layer via either a vacuum evaporation or electroplating method.

6. The plastic article of claim 1, wherein the base layer is either transparent or translucent for highlighting a natural color of the outer surface.

7. The plastic article of claim 1, wherein the film further comprises a first pattern layer having patterns and/or characters thereon and sandwiched between the base layer and the attaching layer, and a second pattern layer directly attached to the base layer opposite to the pattern layer.

8. The plastic article of claim 1, wherein the film fully covers the top portion and the flange.

9. The plastic article of claim 1, wherein the film fully covers the top portion.

10. The plastic article of claim 1, wherein the attaching layer is for attaching the film to the outer surface of the plastic article, the attaching layer may be made from a plurality of resin materials consisting of acrylic, nitrification fiber, polyamine formate, chlorination rubber, vinyl chloride-co-vinyl-acetic ester copolymer, polyamide, polyester, epoxy, polycarbonate, olefin, and acrylonitrile-butylene-styrene monomer resin.

11. A plastic article, comprising:
a base formed by injecting molten resin into a cavity of a female mold, the base comprises a top portion and a flange extending from edges of the top portion; and
a film attached to the base;
wherein the base comprises a first edge formed from edges of the flange, the film comprises a second edge level to the first edge of the base, the film fully covers the top portion and the flange.

12. The plastic article of claim 11, wherein the film comprises a base layer and an attaching layer.

13. The plastic article of claim 12, wherein the film further comprises a pattern layer having patterns and/or characters printed on the base layer and sandwiched between the base layer and the attaching layer.

14. The plastic article of claim 13, wherein the base layer is either transparent or translucent to reveal the pattern and/or characters of the pattern layer.

15. The plastic article of claim 13, wherein the pattern layer comprises a plurality of ink layers provided via screen printing, a thickness of each ink layer ranges from about 0.005 millimeters to about 0.02 millimeters.

16. The plastic article of claim 11, wherein the base layer is either transparent or translucent for highlighting a natural color of the outer surface.

17. The plastic article of claim 11, wherein the film further comprises a first pattern layer having patterns and/or characters thereon and sandwiched between the base layer and the attaching layer, and a second pattern layer directly attached to the base layer opposite to the pattern layer.

18. The plastic article of claim 11, wherein the pattern layer is arranged on the inner surface of the base layer, the pattern layer comprises a plurality of ink layers provided via screen printing, the thickness of each ink layer ranges from about 0.005 millimeters to about 0.02 millimeters.

19. The plastic article of claim 18, wherein a metal decorative layer is provided as the pattern layer, the metal decorative layer plating may be aluminum, chromium, copper, nickel, indium, or tin, alone or combined, on the base layer via either a vacuum evaporation or electroplating method.
